(19) United States
(12) Patent Application Publication
(10) Pub. No.: US 2022/0315859 A1
(43) Pub. Date: Oct. 6, 2022

(54) PLANT OIL EXTRACTION DEVICE

(71) Applicant: Dalrada Health Products, Escondido, CA (US)

(72) Inventors: Stuart Cox, Edinburgh (GB); David Pickett, McKinney, TX (US)

(21) Appl. No.: 17/642,651

(22) PCT Filed: Sep. 14, 2020
(86) PCT No.: PCT/US2020/050760

§ 371 Date: Mar. 11, 2022

Related U.S. Application Data
(60) Provisional application No. 62/900,270, filed on Sep. 13, 2019.

(51) Int. Cl. C11B 1/10; B01D 11/02; B01D 61/02

(52) U.S. Cl. CPC C11B 1/104; B01D 11/0203; B01D 61/027; B01D 11/0257; B01D 11/0292; B01D 11/0265; B01D 2311/26

(57) ABSTRACT

A plant oil extraction device includes one or modules for extraction of a product, e.g., oil, from a plant biomass. Various embodiments of the plant oil extraction device are described that include one or more features for producing a clean organic stream, free from waxes and terpenes, from biomass feedstocks such as industrial hemp. Related systems, methods, and articles of manufacture are also described.

### TECHNICAL FIELD

The subject matter described herein relates to devices and processes for producing a clean organic stream, free from waxes and terpenes, from biomass feedstocks such as industrial hemp.

### BACKGROUND

Plants produce numerous products that are commercially important. For example, hemp and marijuana produce cannabichromene (CBC), cannabigerol (CBG), tetrahydrocannabinol (THC), cannabidiol (CBD), cannabinol (CBN), cannabinodiol (CBDL), other cannabinoids including cannabielsoin (CBE) and cannabitriol (CBT), cannabicyclol (CBL), as well as wax, terpenes, etc. These compounds can be used in pharmaceuticals, neutraceuticals, and other products. There is a need for improved technology for the processing of plant oils and other products, for example oils from marijuana or hemp.

### SUMMARY

In certain aspects of the current subject matter, challenges associated with producing a clean organic stream, free from waxes and terpenes, from biomass feedstocks, such as industrial hemp, can be addressed by inclusion of one or more of the features described herein or comparable/equivalent approaches as would be understood by one of ordinary skill in the art. Aspects of the current subject matter relate to methods and system for the processing of plant oils and other products, for example oils from marijuana or hemp in a plant oil extraction device.

In some variations, one or more of the following features may optionally be included in any feasible combination. For example, a device for extraction of an organic stream from a plant or plant material may include a product feeder. The device may include a conditioning module comprising an oven. The device may include a continuous extraction module comprising at least one removable tube, wherein the continuous extraction module is operably linked to a tank containing CO2. The device may include a filtration module. The filtration module may include an OSN (organic solvent nanoseparation) in an integrated membrane separation process following separation of the crude oils from the supercritical CO2.

The organic stream may include an oil. The organic stream may include cannabidiol (CBD). The organic stream may be substantially free from waxes. The organic stream may be substantially free from terpenes. The product feeder may be configured to receive plant material, biomass, or other product into a receiving receptacle to be fed into a basket filling machine for product processing. The conditioning module may be configured to condition and heat the biomass.

The continuous extraction module may be configured to receive a biomass tube, purge and fill with carbon dioxide. The continuous extraction module may be configured to circulate carbon dioxide in a first pass. The continuous extraction module may be configured to circulate carbon dioxide in a second pass. The continuous extraction module may be configured to vent, open and remove the spent biomass tube. The filtration module may be configured to produce two streams, one of supercritical carbon dioxide with waxes and terpenes, and one of supercritical carbon dioxide with the organic oils, such as CBD oils.

A method for extracting an organic stream from a plant or plant material may include feeding a pre-treated plant material into the product feeder of the device for extraction of an organic stream from a plant or plant material.

A method for extracting an organic stream from a plant or plant material may include providing a prepared biomass. The method may include receiving the prepared biomass into an extraction vessel. The method may include extracting a product from the biomass by contacting the biomass in the extraction vessel with a solvent and carbon dioxide to provide an extract. The method may include membrane purification of the extract to produce a wax product and the organic stream. The prepared biomass may be de-lumped and/or milled, prior to being received into the system.

The continuous extraction vessel may include a plurality of tubes configured to provide output. The continuous extraction vessel may be configured to receive a biomass tube, purge and fill with carbon dioxide. The continuous extraction vessel may be configured to circulate supercritical carbon dioxide in a first pass. The continuous extraction vessel may be configured to circulate supercritical carbon dioxide in a second pass. The continuous extraction vessel may be configured to vent, open and remove the spent biomass tube.

The supercritical carbon dioxide may be passed through a membrane filtration process to produce two streams, one of supercritical carbon dioxide with waxes and terpenes, and one of supercritical carbon dioxide with the organic oils, such as CBD oils. Alternatively, OSN (organic solvent nanoseparation) may be used in an integrated membrane separation process following separation of the crude oils from the supercritical CO2. The supercritical carbon dioxide flow may be continuous and between about 1500 and about 3500 kg/h.

Winterizing, or membrane purification, of the extract may include the steps of receiving raw biomass extract from the continuous extraction vessel; combining the raw biomass extract with alcohol and stirring vigorously until completely mixed; freezing the mixture at below-zero temperature; removing frozen fats, waxes, and lipids to produce clean biomass oil; and/or filtering the alcohol from the clean biomass oil.

The distillation of the winterized or membrane purified product may produce terpenes, and oil having at least about 80% purity of the oil. The oil may have at least about 90% purity. The organic stream may be the organic oil product. The organic oil product may include one or more cannabinoids.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated into and constitute a part of this specification, show certain aspects of the subject matter disclosed herein and, together with the description, help explain some of the principles associated with the disclosed implementations. In the drawings:

FIG. 1 illustrates an embodiment of a plant oil extraction system;

FIG. 2 illustrates an embodiment of a first module of a plant oil extraction system;

FIG. 3 illustrates an embodiment of a second module of a plant oil extraction system;

FIG. 4 illustrates an embodiment of a plant oil extraction system;

FIG. 5 illustrates a perspective view of another embodiment of a plant oil extraction system;

FIG. 6 illustrates a method of a plant oil extraction system;

FIG. 7 illustrates a method of a plant oil extraction system (continued from FIG. 6);

FIG. 8 illustrates a method of a plant oil extraction system (continued from FIG. 7); and

FIG. 9A-17B illustrate embodiments of a plant oil extraction system.

When practical, similar reference numbers denote similar structures, features, or elements.

### DETAILED DESCRIPTION

Implementations of the current subject matter include methods, apparatuses, articles of manufacture, and systems relating to producing a clean organic stream, free from waxes and terpenes, from biomass feedstocks such as industrial hemp. Some features that may be present include (but are not limited to):
Feed pretreatment.
Conditioning of the feed biomass to decarboxylate the acid forms (if required).
Two pass flow-through extraction using supercritical carbon dioxide in the pressure range 150 to 300 bar and temperature range 50 to 100° C.
Membrane separation of waxes from the supercritical stream.
Continuous recirculation of the carbon dioxide solvent.
Physical separation of the plant oils, such as CBD oil, from industrial hemp or other plant biomass.
Integration with state-of-the-art separation processes for individual organic compounds.

In an aspect, a device (machine) for processing of plants to extract an organic stream, for example plant oil, is provided.

In embodiments, the plant oil extraction system provides a continuous-flow extraction process for extraction and purification of plant oil. A continuous-flow extraction process allows for processing much greater volumes of raw material without having to stop and restart material flows, and allows for scaling-up to higher throughputs easily, without the need for costly additional machine time and human labor. Continuous-flow extraction allows for better control over extraction time and temperature, so that the negative effects typically associated with heating are minimized.

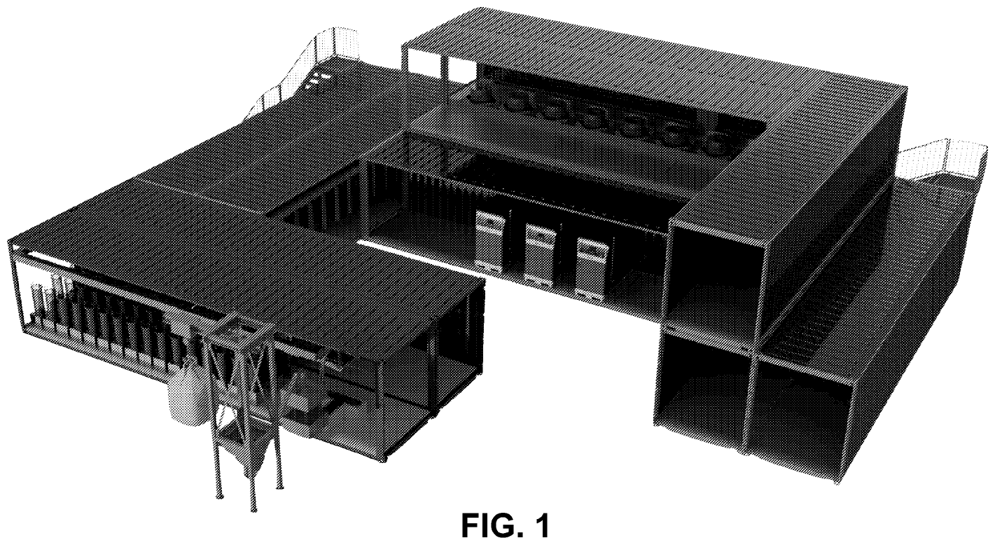

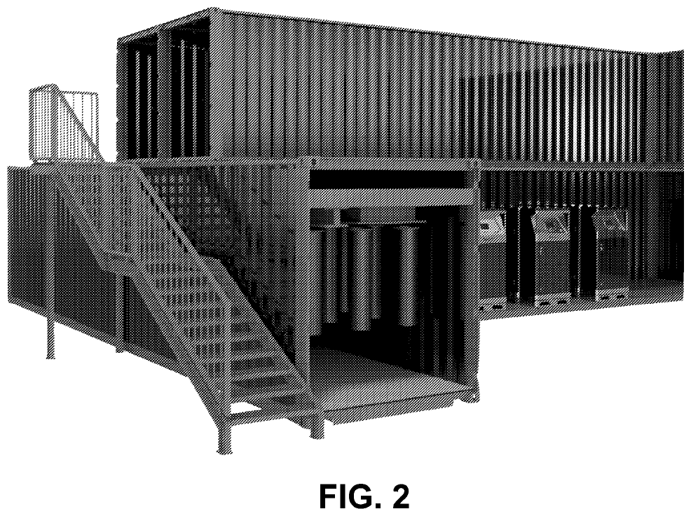

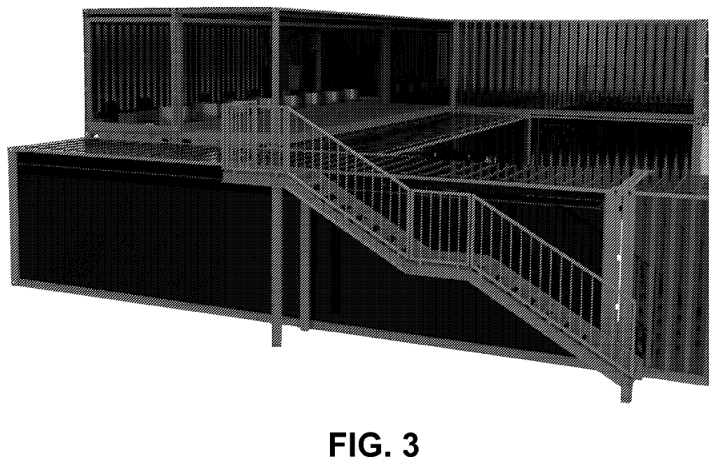

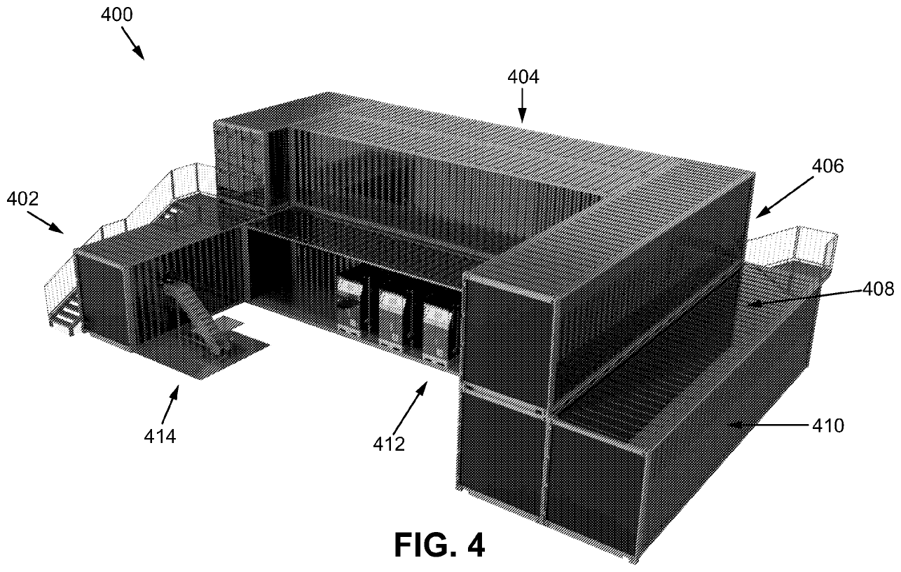

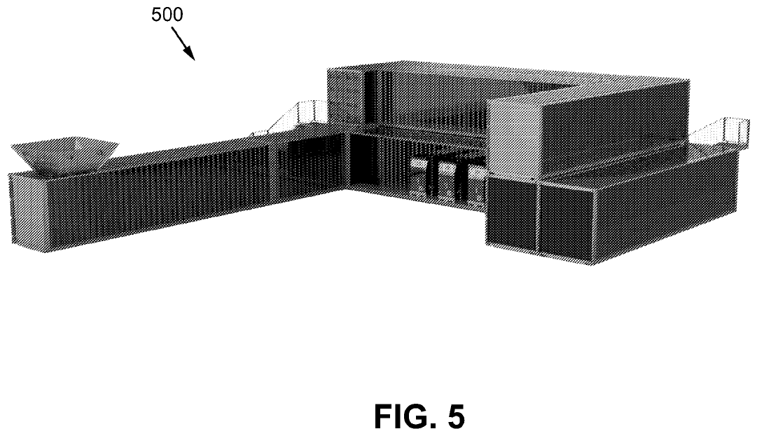

FIGS. 1-5 illustrate renderings of the outside of exemplary devices, and optional crates for shipping of modules of the device. FIGS. 1-5 illustrate examples and embodiments for illustrative purposes only. Various modifications or changes in light thereof will be suggested to persons skilled in the art and are to be included within the spirit and purview of this application and scope of the appended claims. For example, FIGS. 1-5 may be modular structure (e.g., prefabricated modules).

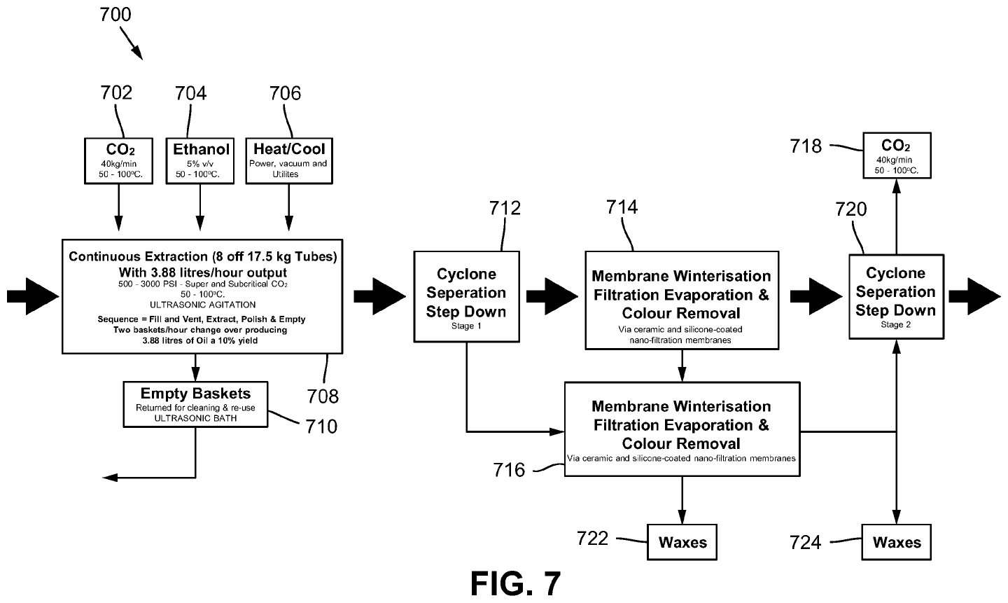

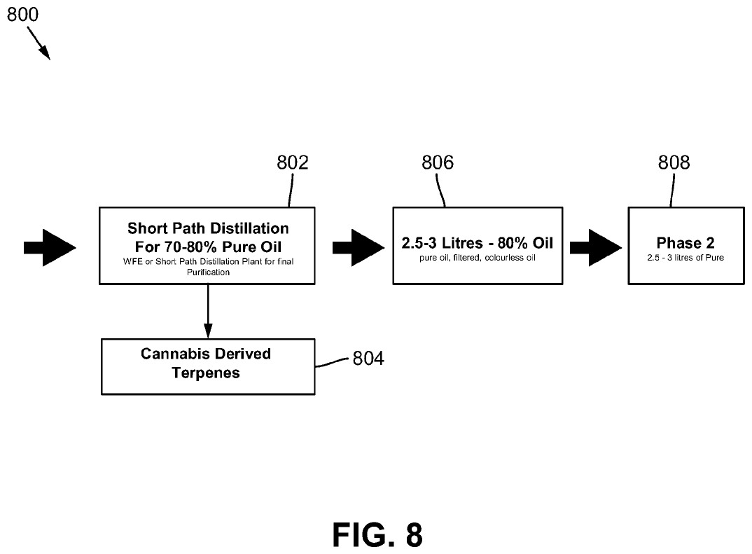

FIG. 7 illustrates an embodiment of a plant oil extraction system 400. The plant oil extraction system 400 may include a pre-treated product feeder 414. The pre-treated product feeder 414 may be configured to receive plant material, biomass, and/or other product into a receiving receptacle. The pre-treated product feeder 414 may accept clean, dried biomass, for example in 250-pound (lb.) supersacks or similar packaging. The biomass may be received into the system and de-lumped, followed by milling to a typical size range of 0.1 to 5.0 mm, e.g., 0.5 to 2.0 mm. In embodiments, the biomass is pretreated, such as de-lumped and/or milled, prior to being received into the system. The product may be pretreated with an optional pre-treatment module 500, as shown in FIG. 8. Optional pre-treatment module 500 may include a milling system configured to pre-process the feed in the event that the feed is not received in a physical form ready for use in the extraction process.

The plant oil extraction system 400 may include a basket filling machine 402. The basket filling machine 402 may be an automated process. The prepared feed may be packed into stainless steel tubes of about 25 liters to about 200 liters capacity, for example about 80 liters capacity. The tubes can be processed immediately or can be heat treated for up to 24 hours at a controlled temperature, e.g. in the range ambient to about 200 degrees C., or ambient to about 100 degrees C., to decarboxylate the oils. In some embodiments, the maximum temperature for heat treatment of the feed material should be no more than 100 degrees C.

The plant oil extraction system 400 may include a continuous extraction device 404. The continuous extraction device 404 may include a plurality of tubes to provide output. The plurality of tubes may be in groups of three or four. For example, eight tubes may provide an output of between 1 liter/hour (L/h) and 10 L/h. In embodiments, eight tubes may provide an output of between 1 L/h and 5 L/h. In embodiments, eight tubes may provide an output of between 2 L/h and 5 L/h. In embodiments, eight tubes may provide an output of about 4 L/h, e.g. about 3.88 L/h. Output may be any value or subrange within the provided ranged, including endpoints. In some embodiments, the extraction tubes may be in groups of three or four (e.g., 2×4 extraction tubes, based on a maximum pressure of 300 bar).

The extraction process module may include between one and 20, for example 1, 2, 3, 4, 5, 6, 7, 8, 9, 10, 11, 12, 13, 14, 15, 16, 17, 18, 19 or 20, stainless steel (or comparable material) extraction vessels. Extraction vessels may include automatic top closures. Extraction vessels may include side heating jackets. The chamber of each vessel may be between 5 and 15 inches, e.g., 8 inches, internal diameter and accept a tube containing biomass up to about 2 meters long, or up to about 1.4 meters long. The process may operate in the range of 100 to 400 bar, or 150 to 300 bar. Pressure may be any value or subrange within the provided ranged, including endpoints. The process may operate in the range of 25 to 150 degrees C., e.g., 50 to 100 degrees C. Temperature may be any value or subrange within the provided ranged, including endpoints. It is preferable to have high integrity closures, and filling and emptying operations that are sufficiently automated to avoid any manual contact.

Each extraction vessel can undergo up to four stages of operation, with between 30 minutes and 5 hours, e.g. about one hour, per stage for each cycle:
Insert biomass tube, purge and fill with carbon dioxide.
Supercritical carbon dioxide circulation, first pass.
Supercritical carbon dioxide circulation, second pass.
Vent, open and remove spent biomass tube.

There may be any number of tubes at each stage of operation at any time, e.g., 0, 1, 2, 3, 4, 5, 6, 7, 8, 9, 10, etc. In some embodiments, there is at least one tube at each stage of operation at any time. The supercritical carbon dioxide flow may be continuous. The supercritical carbon dioxide flow may be between about 1500 and about 3500 kg/h (e.g., for a plant with 8 extraction tubes), for example, about 2500 kg/h. Supercritical carbon dioxide flow may be any value or subrange within the provided ranged, including endpoints.

Following two passes through the extraction vessels, the supercritical carbon dioxide may be passed through one or more pressure reduction stages to separate the oils and waxes into one or more crude streams.

After product separation, the carbon dioxide is expected to be a gas, e.g. at approximately 60 bar pressure. This can be cooled to condense it as a liquid for recycle to the circulation pump. The system may incorporate heat exchangers for temperature control throughout the loop, along with pressure and flow controls and make-up with carbon dioxide from storage. The majority of the carbon dioxide vented from the spent extraction vessels can be returned to the low pressure part of the loop for recycle.

Heating and cooling may be provided by highly efficient heat pumps using refrigerant, e.g., environmentally friendly refrigerant. A utilities module may provide power, process controls, and/or ventilation for the process areas and conditioning ovens.

The oil product can be further separated and purified using state-of-the-art separation processes for individual organic compounds, such as liquid chromatography, short path distillation, centrifugal liquid extraction, or fast centrifugal partition chromatography.

In embodiments, the oil product is between about 50% and 100% pure. In embodiments, the oil product is at least about 50% pure. In embodiments, the oil product is at least about 60% pure. In embodiments, the oil product is at least about 70% pure. In embodiments, the oil product is at least about 80% pure. In embodiments, the oil product is at least about 85% pure. In embodiments, the oil product is at least about 90% pure. In embodiments, the oil product is at least about 95% pure. In embodiments, the oil product is at least about 96% pure. In embodiments, the oil product is at least about 97% pure. In embodiments, the oil product is at least about 98% pure. In embodiments, the oil product is at least about 99% pure. In embodiments, the oil product is about 100% pure. Purity may be any value or subrange within the recited ranges, including endpoints. Purity refers to the absence of contaminants, including, but not limited to, solvents (i.e., used in the manufacturing/extraction process), microbial contamination, terpenes, fatty acids, and heavy metals.

The plant oil extraction system 400 may include a membrane separation device 406. Membrane separation device 406 may include ceramic and silicone-coated organic solvent nano-filtration (OSN) membranes in an integrated process with solvent recovery and recirculation. The membrane process removes impurities, including lipids and fatty acids.

The plant oil extraction system 400 may include an optional space for a quality assurance laboratory 408.

The plant oil extraction system 400 may include an isolation/fractionation suite 410. The isolation/fractionation suite 410 may produce cannabis-derived terpenes, waxes, limonene d, CBD, CBN, THC, CBD-G, CBD-A, THC-A, and other cannabinoids.

In some embodiments, the plant oil extraction system 400 may include a CO2 generation device 412. The CO₂ generation device 412 may include heating and cooling utilities.

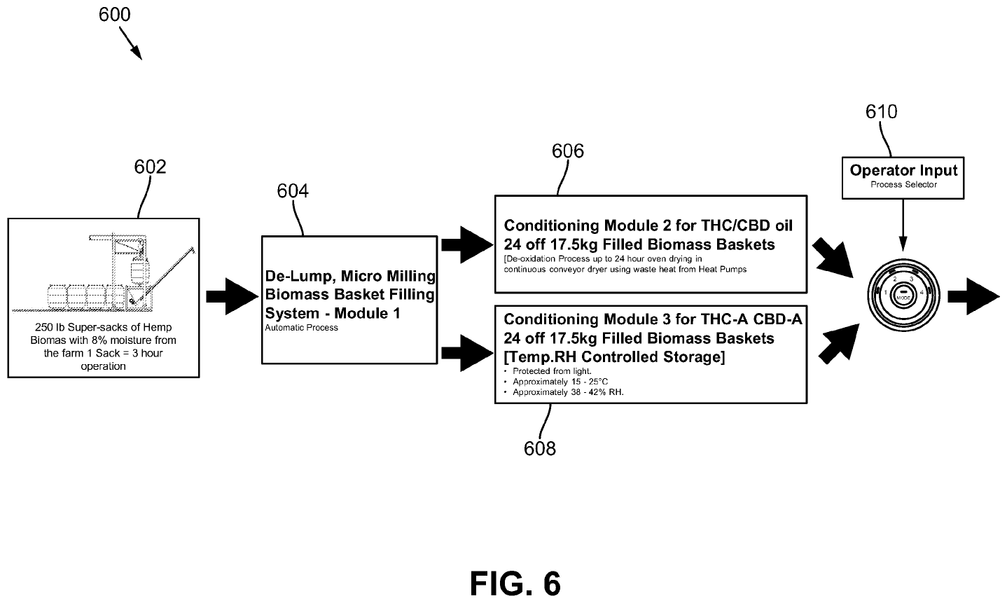

FIGS. 6-8 illustrate exemplary devices and an example flowchart for processing plant materials, e.g., cannabis or hemp, to extract plant oils and other products, such as terpenes, CBD or THC.

FIGS. 6-17 illustrate example process steps. Any step may be omitted or repeated, additional steps may be added, and/or the steps may be performed in a different order. The steps may be performed in any order.

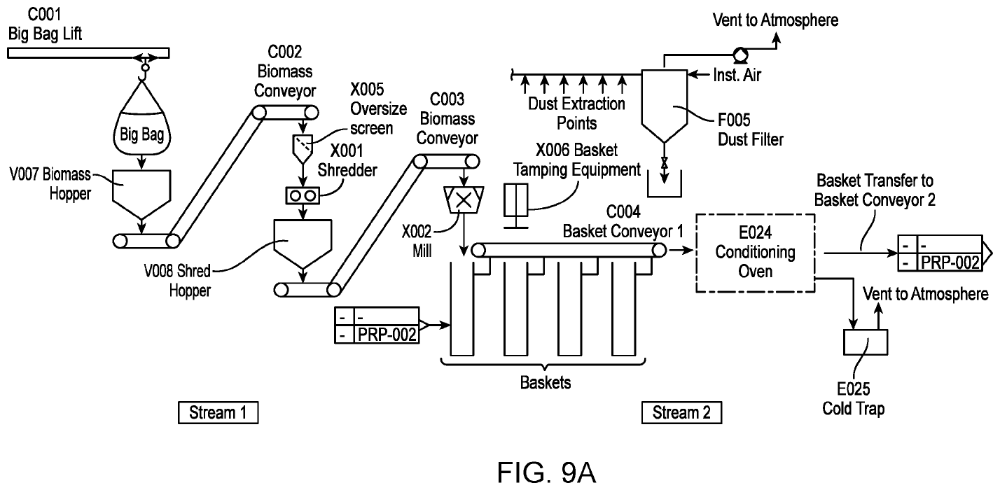

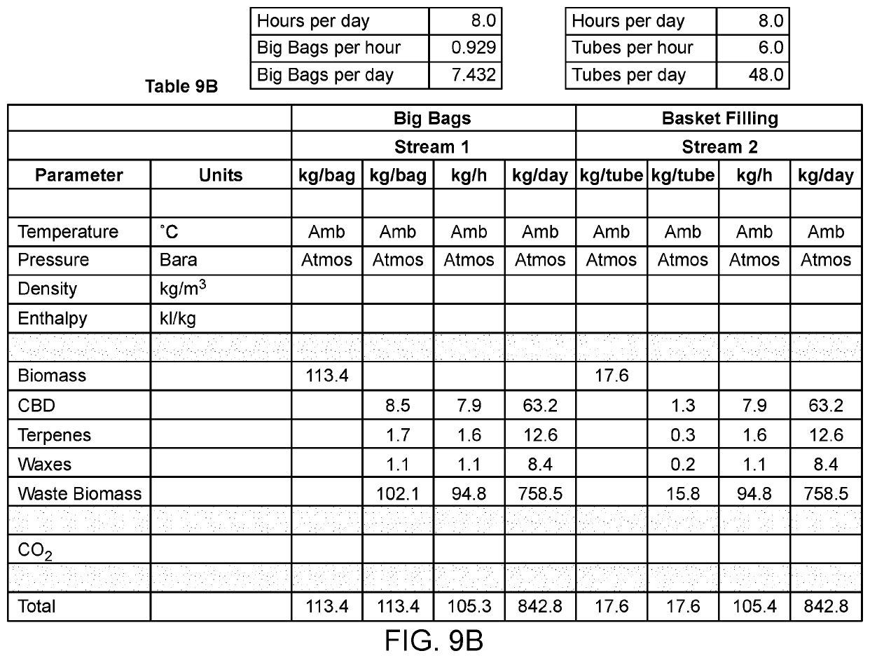

FIGS. 9A-17B illustrate a schematic of an example device and process for plant oil extraction.

At a first stream, as shown in FIG. 9A, biomass may be provided into a biomass hopper via a big bag (or similar storage unit) for delivery of the biomass onto a biomass conveyor. From the biomass conveyor, the biomass may be deposited through an oversize screen and into a shredder configured to shred the biomass. The shredded biomass may then be provided into a shred hopper for delivery of the biomass onto a shred conveyor. From the shred conveyor, the biomass may be deposited through a mill and into one or more baskets.

At a second stream, the baskets of milled biomass may be conveyed by a first basket conveyor to a conditioning oven for conditioning/heating of the biomass. The air vent from the conditioning oven may be dispelled into a cold trap. The cold trap may be configured to vent into the atmosphere. From the conditioning oven, the baskets containing conditioned biomass may be transferred to a second basket conveyor. Table 9B in FIG. 9B illustrates example outputs of the first and second streams of FIG. 9A.

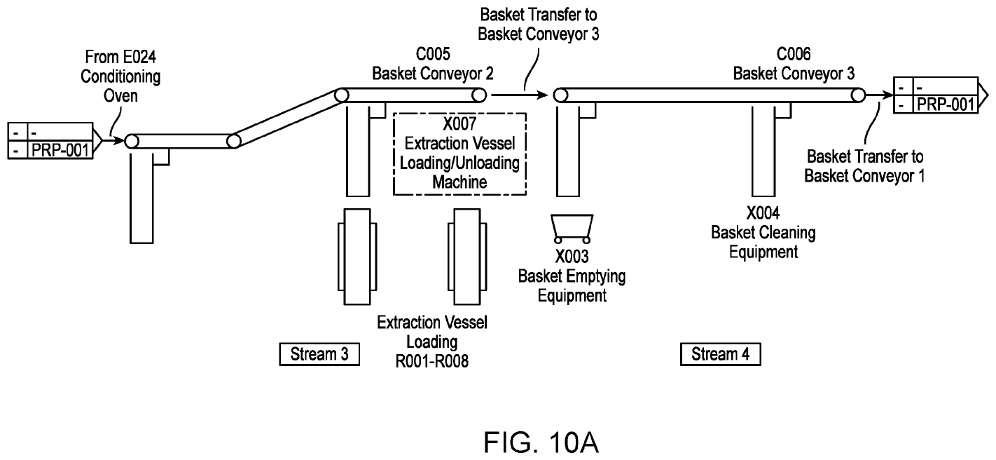

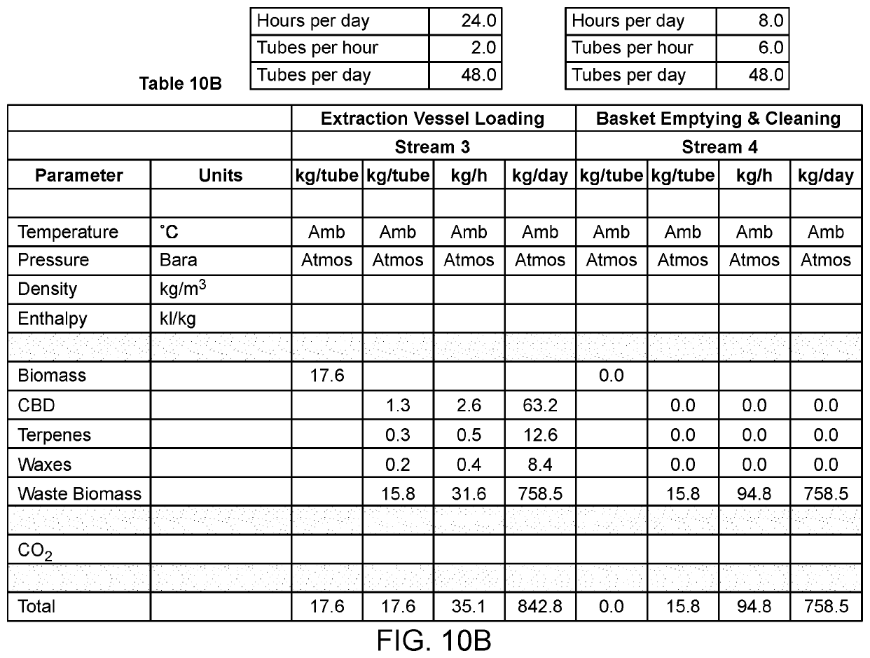

At a third stream, as shown in FIG. 10A, the second basket conveyor may deliver the baskets to an extraction vessel loading/unloading machine for extraction vessel loading. At a fourth stream, the baskets may be emptied with basket emptying equipment and the empty baskets may be transferred to a third basket conveyor and conveyed through basket cleaning equipment for cleaning and back to the first basket conveyor for reuse. Table 10B in FIG. 10B illustrates example outputs of the third and fourth streams of FIG. 10A.

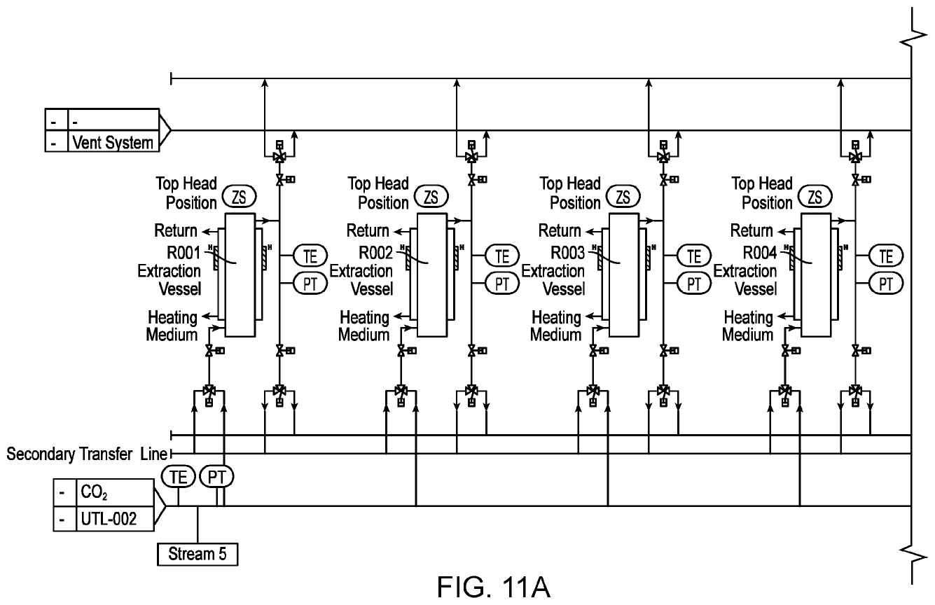

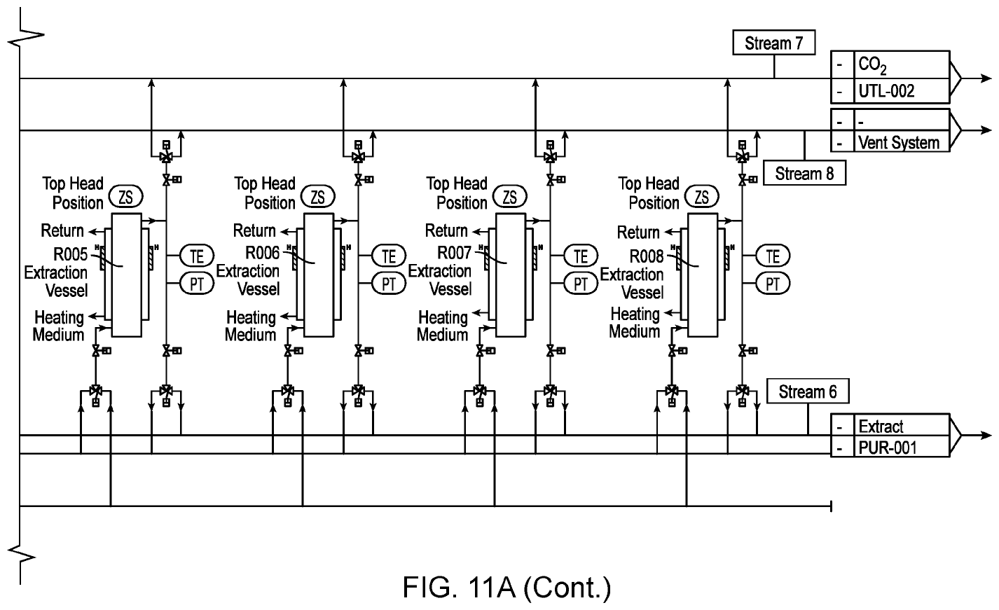

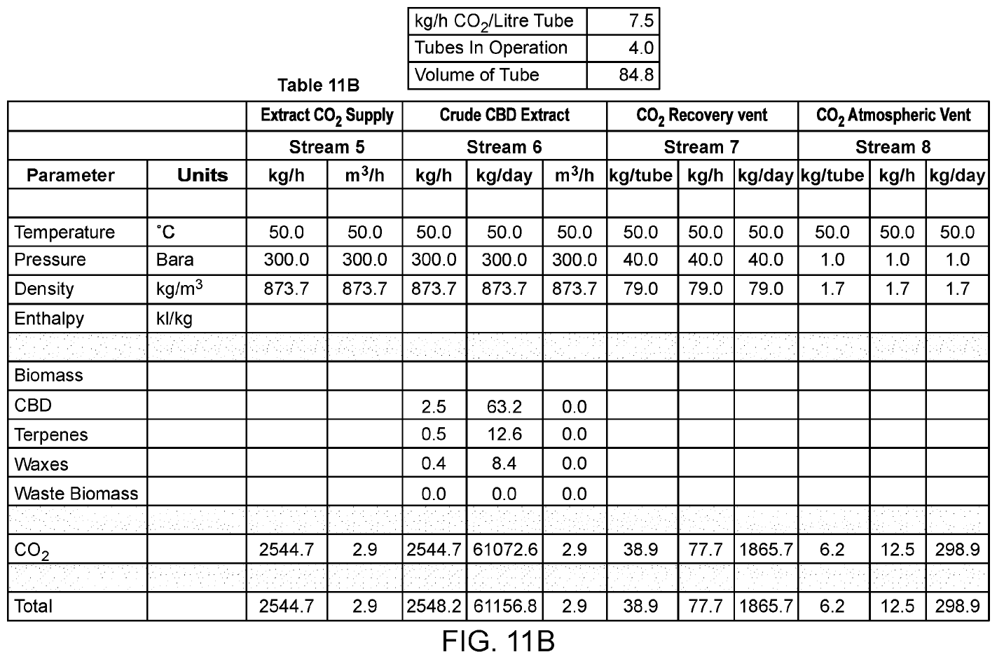

At a fifth stream, as shown in FIG. 11A, any number of extraction vessels, each containing one or more tubes, may be present in the extraction process module. For example, the extraction vessel may include one tube, and be in groups of three or four. The extraction vessels may be heated to 25 degrees C. to 150 degrees C. by a heating medium, at a pressure of 100 to 400 bar, or 150 to 300 bar. A solvent (e.g., ethanol 5% v/v) can be added to the extraction vessels. Suitable solvents are well known in the art, including ethanol, butane, propane, isopropyl, or other alcohol. Supercritical carbon dioxide can be pumped through the extraction vessels. The supercritical carbon dioxide flow may be continuous. The supercritical carbon dioxide flow may be between about 1500 and about 3500 kg/h, for example about 2500 kg/h. Each extraction vessel can undergo up to four stages of operation, with between 30 minutes and 5 hours, e.g. about one hour, per stage for each cycle:
Insert biomass tube, purge and fill with carbon dioxide.
Supercritical carbon dioxide circulation, first pass.
Supercritical carbon dioxide circulation, second pass.
Vent, open and remove spent biomass tube.

The continuous extraction process may be performed in the presence of agitation of the biomass, e.g. by ultrasonic agitation. The extraction process module may include a vent system to vent excess carbon dioxide or other gasses from the extraction vessels. Carbon dioxide from the extraction process may be recaptured and re-used.

Table 11B in FIG. 11B illustrates example outputs of the fifth through eighth streams of FIG. 11A.

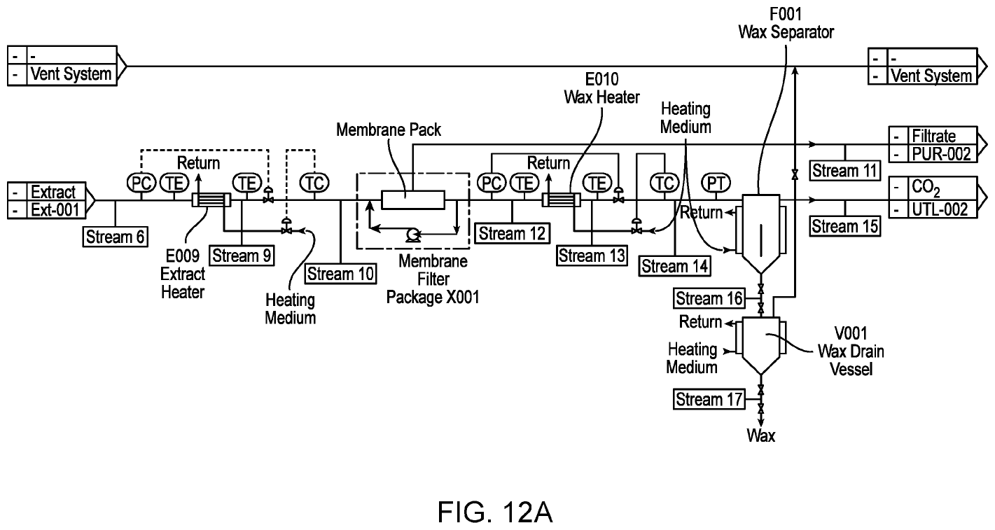

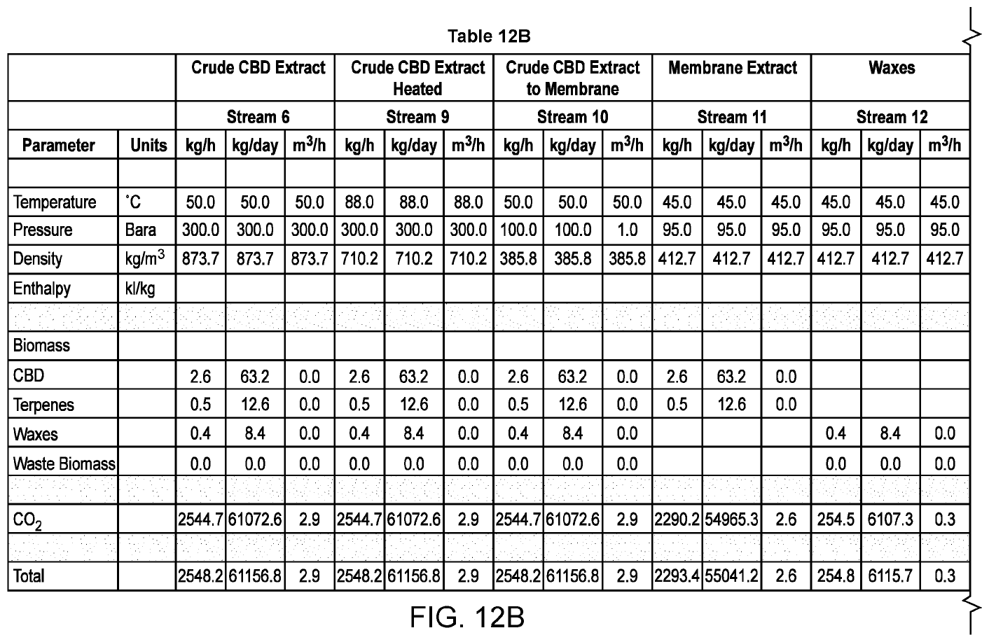

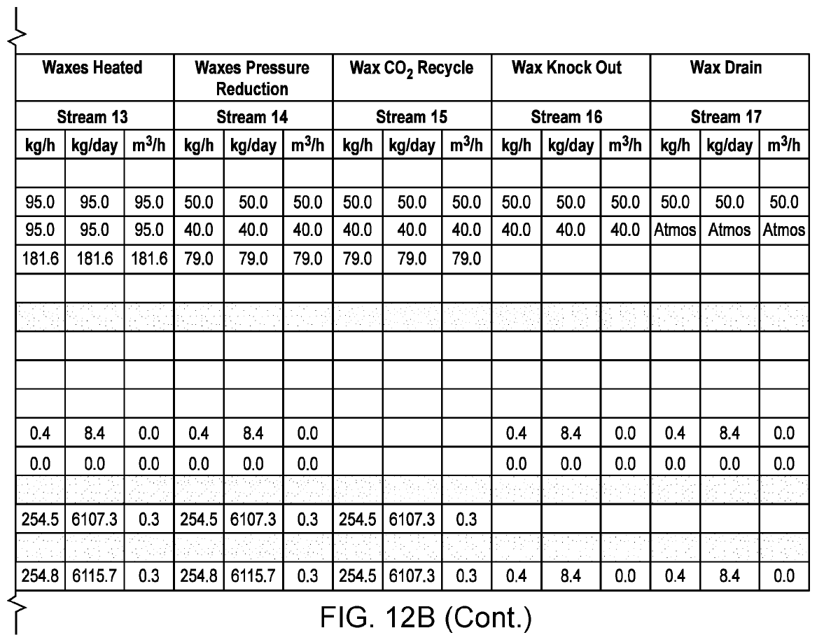

At a ninth stream, as shown in FIG. 12A, the output from the extraction process module may be subjected to heat, followed by membrane filtration to produce two streams, one of carbon dioxide with waxes and terpenes (stream 12), and one of carbon dioxide with the organic oils, such as CBD oils (stream 11). The stream containing carbon dioxide with waxes and terpenes can be moved (automatically or manually) to the wax separator. Stream 16 contains wax and flows into the wax drain vessel.

Table 12B in FIG. 12B illustrates example outputs of the sixth, and ninth through seventeenth streams of FIG. 12A.

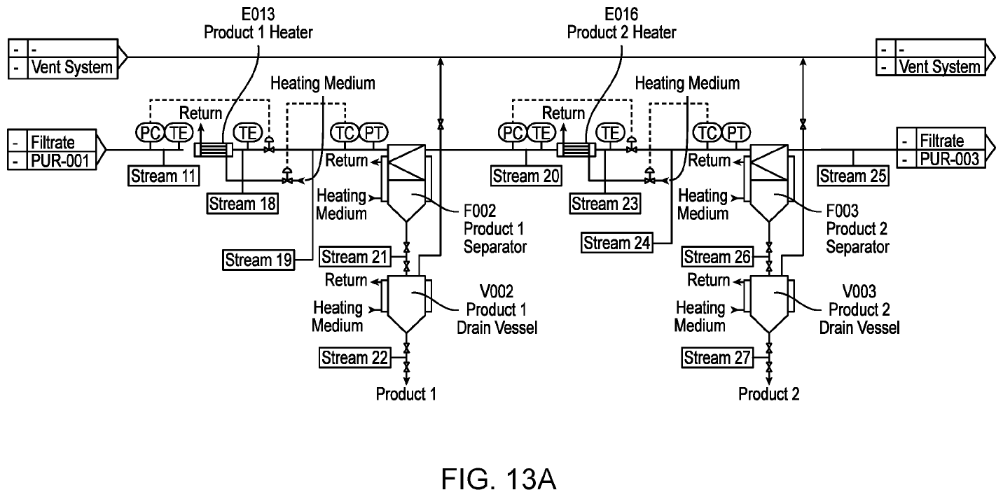

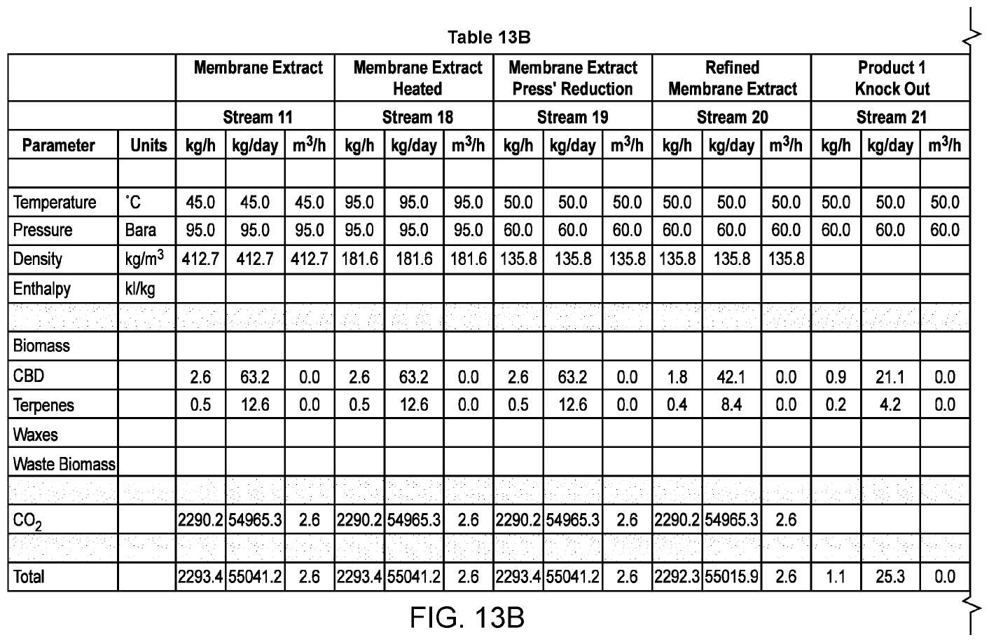

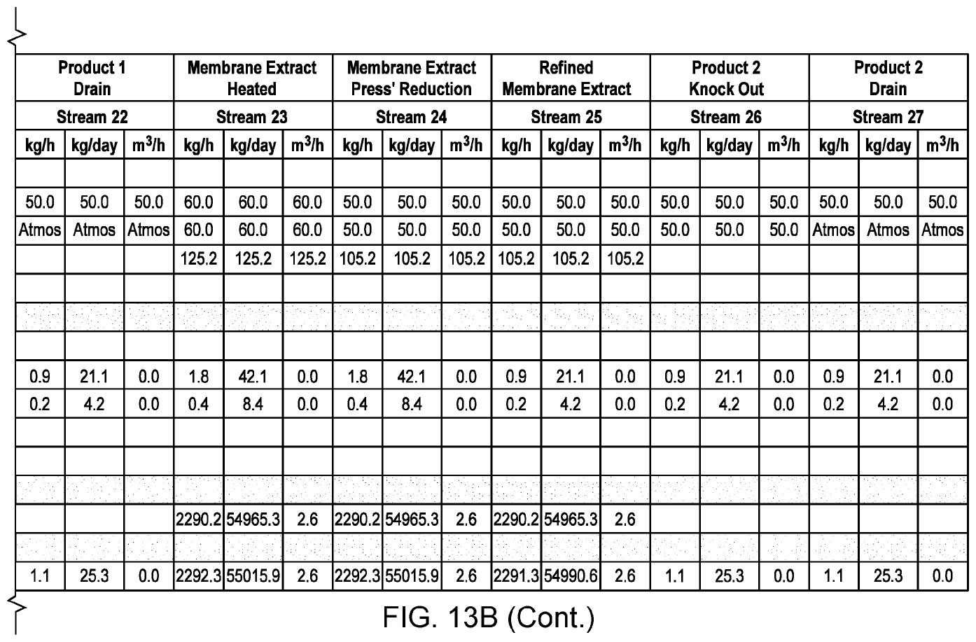

As shown in FIG. 13A, the eleventh stream, containing carbon dioxide with the organic oils, such as CBD oils, is heated at the product heater and the resulting stream flows into the product separator to separate various desired products. These may be drained through the drain vessel (stream 22). Additional heaters and product separators may be included for recovery of additional products, depending on the biomass feedstock and the desired product(s).

Table 13B in FIG. 13B illustrates example outputs of the eleventh, and eighteenth through twenty-seventh streams of FIG. 13A.

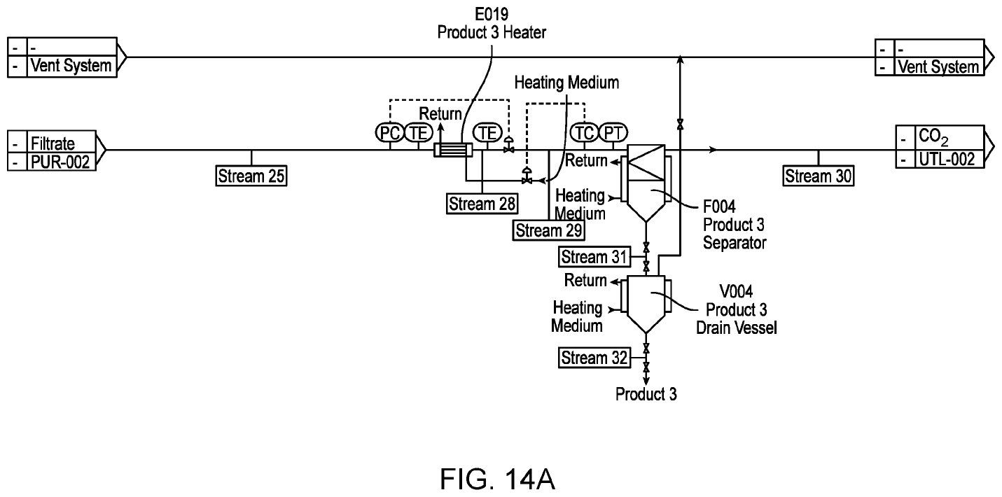

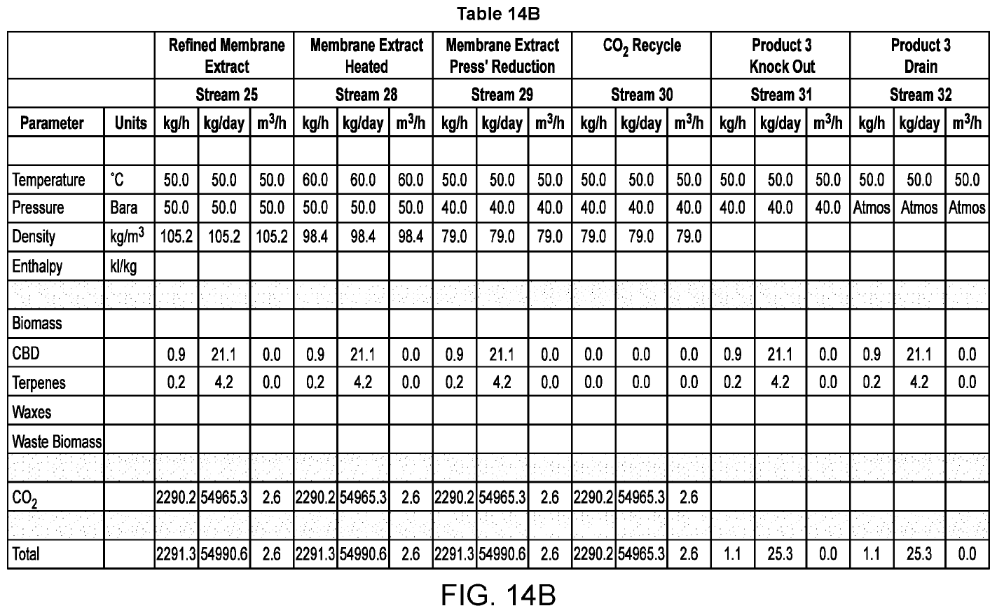

At a twenty-fifth stream, as shown in FIG. 14A, additional product(s) may be recovered.

Table 14B in FIG. 14B illustrates example outputs of the twenty-fifth, and twenty-sixth through thirty-second streams of FIG. 14A.

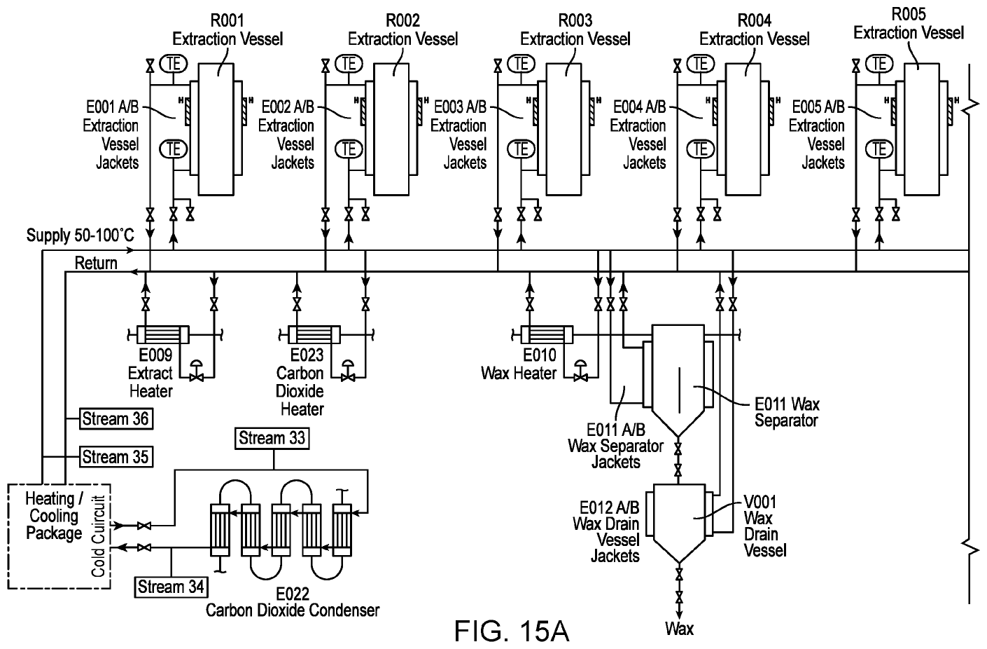

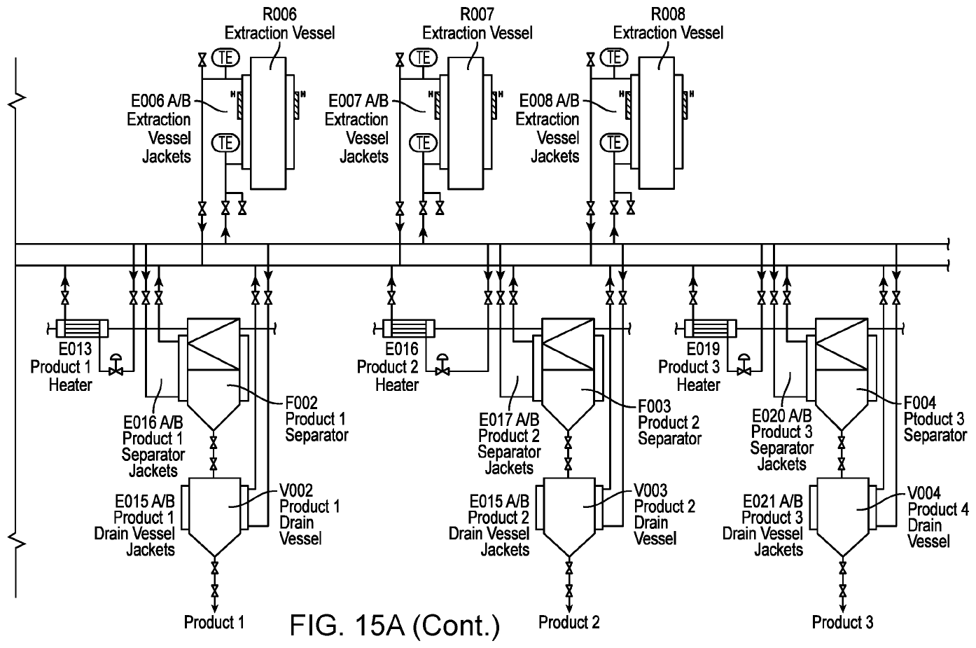

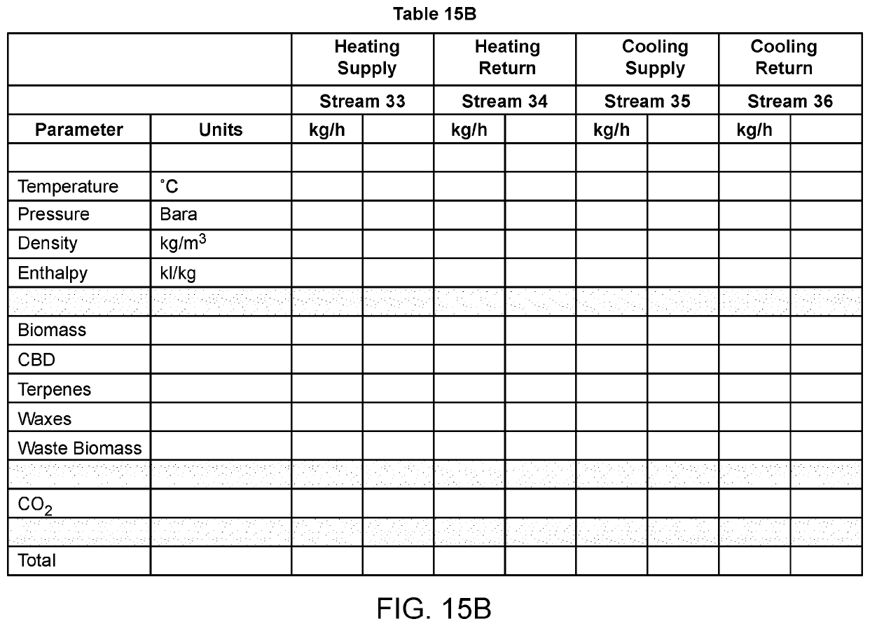

At a thirty-third stream, as shown in FIG. 15A, the carbon dioxide recovered from the process may be recovered using a carbon dioxide condenser, and re-used in the extraction process.

Table 15B in FIG. 15B illustrates example outputs of the thirty-third through thirty-sixth streams of FIG. 15A.

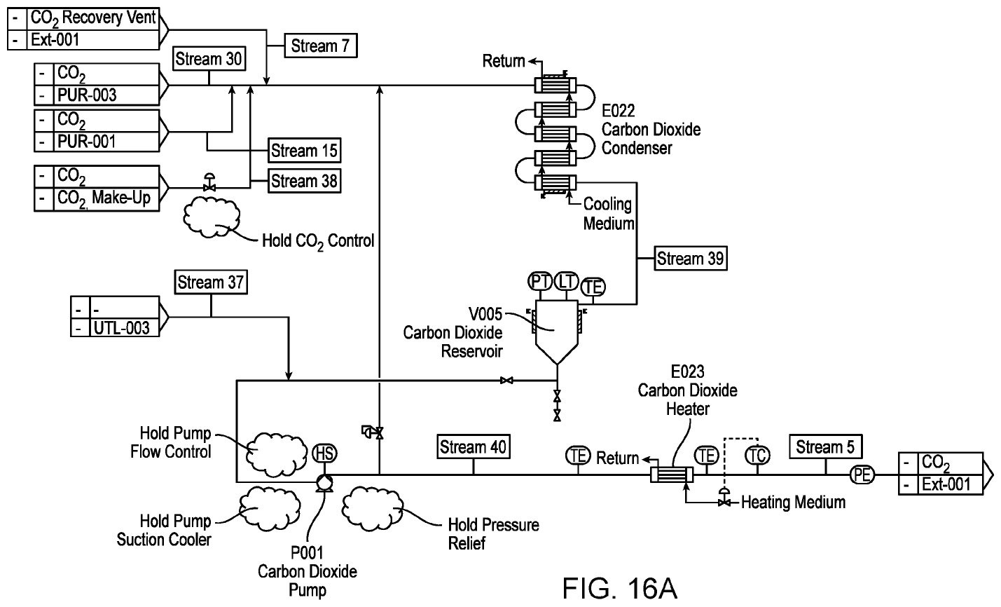

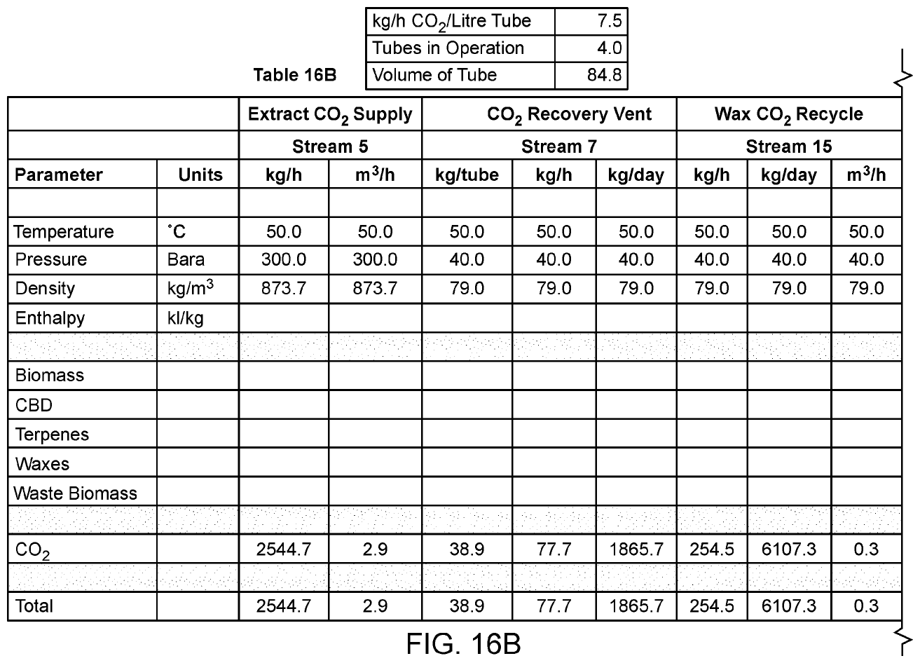

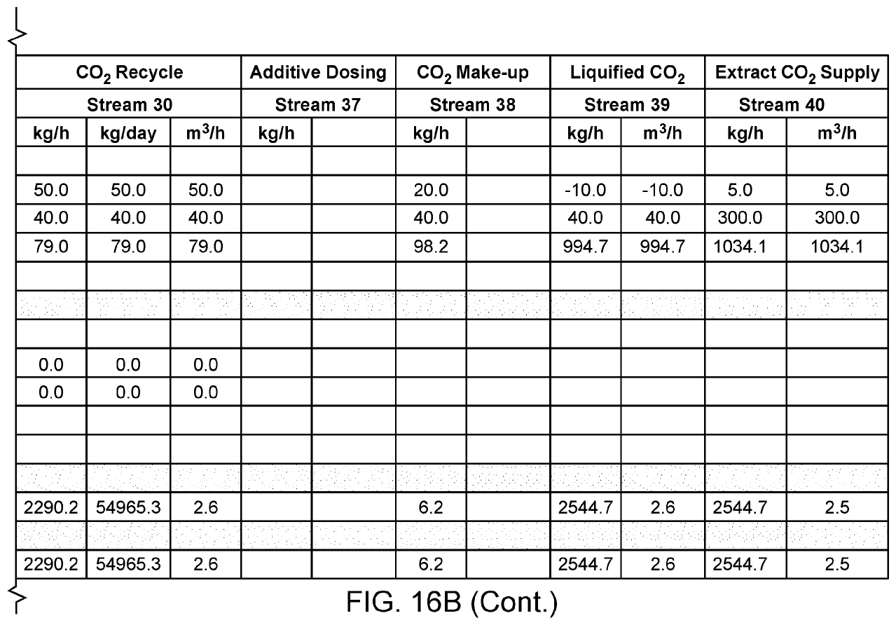

FIG. 16A provides another illustration of carbon dioxide recapture. For example, the carbon dioxide recycle system may include a condenser, liquid storage reservoir, recirculation pump, and/or reheater.

Table 16B in FIG. 16B illustrates example outputs of the fifth, seventh, fifteenth, thirtieth, and thirty-seventh through fortieth streams of FIG. 16A.

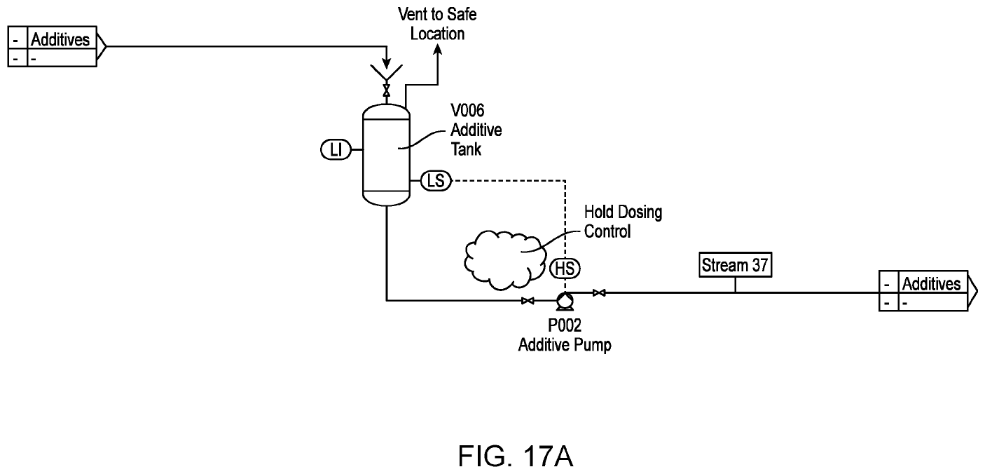

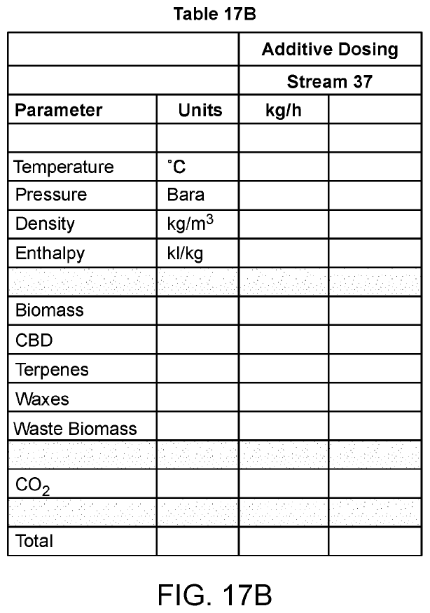

As shown in FIG. 17A, additivities may be added into an additive tank, which may be vented to a safe location. An additive pump may be used to provide additive to the system.

Table 17B in FIG. 17B illustrates example outputs of the thirty-seventh stream of FIG. 17A.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### Terminology

After reading this description, it will become apparent to one skilled in the art how to implement the present disclosure in various alternative embodiments and alternative applications. However, all the various embodiments of the present invention will not be described herein. It will be understood that the embodiments presented here are presented by way of an example only, and not limitation. As such, this detailed description of various alternative embodiments should not be construed to limit the scope or breadth of the present disclosure as set forth herein.

Before the present technology is disclosed and described, it is to be understood that the aspects described below are not limited to specific compositions, methods of preparing such compositions, or uses thereof as such may, of course, vary. It is also to be understood that the terminology used herein is for the purpose of describing particular aspects only and is not intended to be limiting.

The detailed description divided into various sections only for the reader's convenience and disclosure found in any section may be combined with that in another section. Titles or subtitles may be used in the specification for the convenience of a reader, which are not intended to influence the scope of the present disclosure.

Unless defined otherwise, all technical and scientific terms used herein have the same meaning as commonly understood by one of ordinary skill in the art to which this disclosure belongs. In this specification and in the claims that follow, reference will be made to a number of terms that shall be defined to have the following meanings:

The terminology used herein is for the purpose of describing particular embodiments only and is not intended to be limiting. As used herein, the singular forms “a”, “an” and “the” are intended to include the plural forms as well, unless the context clearly indicates otherwise.

“Optional” or “optionally” means that the subsequently described event or circumstance can or cannot occur, and that the description includes instances where the event or circumstance occurs and instances where it does not.

The term “about” when used before a numerical designation, e.g., temperature, time, amount, concentration, and such other, including a range, indicates approximations which may vary by (+) or (−) 10%, 5%, 1%, or any subrange or subvalue there between. Preferably, the term “about” when used with regard to a dose amount means that the dose may vary by +/−10%.

“Comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this disclosure.

1. A device for extraction of an organic stream from a plant or plant material, comprising:
a product feeder;
a conditioning module comprising an oven;
a continuous extraction module comprising at least one removable tube, wherein the continuous extraction module is operably linked to a tank containing CO2; and
a filtration module.

2. The device of claim 1, wherein the filtration module comprises a membrane.

3. The device of claim 1, wherein the organic stream comprises an oil.

4. The device of claim 1, wherein the organic stream comprises cannabidiol (CBD).

5. The device of claim 1, wherein the organic stream is substantially free from waxes.

6. The device of claim 1, wherein the organic stream is substantially free from terpenes.

7. The device of claim 1, wherein the product feeder is configured to receive plant material, biomass, or other product into a receiving receptacle to be fed into a basket filling machine for product processing.

8. The device of claim 1, wherein the conditioning module is configured to condition and heat the biomass.

9. The device of claim 1, wherein the continuous extraction module is configured to:
receive a biomass tube, purge and fill with carbon dioxide;
circulate carbon dioxide in a first pass;
circulate carbon dioxide in a second pass; and
vent, open and remove the spent biomass tube.

10. The device of claim 1, wherein the filtration module is configured to include organic solvent nanoseparation in an integrated membrane separation process.

11. A method for extracting an organic stream from a plant or plant material, comprising:
feeding a pre-treated plant material into a product feeder of a device, the device comprising:
a product feeder;
a conditioning module comprising an oven;
a continuous extraction module comprising at least one removable tube, wherein the continuous extraction module is operably linked to a tank containing CO2; and
a filtration module.

12. A method for extracting an organic stream from a plant or plant material, comprising:
(a) providing a prepared biomass;
(b) receiving the prepared biomass into an extraction vessel;
(c) extracting a product from the biomass by contacting the biomass in the extraction vessel with a solvent and carbon dioxide to provide an extract; and
(d) providing a membrane separation process to produce a wax product and the organic stream.

13. The method of claim 12, wherein the prepared biomass is de-lumped and/or milled, prior to being received.

14. The method of claim 12, wherein the extraction vessel includes a plurality of tubes configured to provide output.

15. The method of claim 12, wherein the extraction vessel is configured to:
receive a biomass tube, purge and fill with carbon dioxide;
circulate supercritical carbon dioxide in a first pass;
circulate supercritical carbon dioxide in a second pass; and
vent, open and remove the spent biomass tube.

16. The method of claim 12 wherein an organic solvent nanoseparation includes in an integrated membrane separation process following separation of crude oils from supercritical CO2.

17. The method of claim 12, wherein the supercritical carbon dioxide is continuous and between about 1500 and about 3500 kg/h.

18. The method of claim 12, wherein membrane purification of the extract comprises the steps of:
receiving raw biomass extract from the extraction process;
combining the raw biomass extract with solvent and stirring vigorously until completely mixed;
recirculating the mixture through organic solvent nano-filtration membranes;
collecting a wax stream and an oil-rich stream; and
purifying the solvent by distillation and returning to the process.

19. The method of claim 18, wherein the distillation of the purified product produces terpenes and oil having at least about 80% purity of the oil.

20. The method of claim 19, the oil has at least about 90% purity.

21. The method of claim 12, wherein the organic stream is an organic oil product.

22. The method of claim 21, wherein the organic oil product comprises one or more cannabinoids.
